(19) United States
(12) Patent Application Publication
(10) Pub. No.: US 2015/0151997 A1
(43) Pub. Date: Jun. 4, 2015

(54) PROCESSES FOR THE BIODEGRADATION OF NDMA

(71) Applicant: Microvi Biotech, Inc., Hayward, CA (US)

(72) Inventors: Fatemeh Razavi-Shirazi, Hayward, CA (US); Mohammad Ali Dorri, Milpitas, CA (US); Ameen(nmn) Razavi, Fremont, CA (US)

(21) Appl. No.: 14/407,882

(22) PCT Filed: Jun. 14, 2013
(86) PCT No.: PCT/US13/45951

§ 371 Date: Dec. 12, 2014

Related U.S. Application Data
(60) Provisional application No. 61/689,945, filed on Jun. 15, 2012.

(51) Int. Cl. C02F 3/34

(52) U.S. Cl. CPC C02F 3/342; C02F 2101/003

(57) ABSTRACT

NDMA can be degraded by Rhodococcus sp. in the presence of sufficient amounts of at least one oxygenated hydrocarbon selected from the group of secondary alcohols, ketones and aldehydes and having up to five carbon atoms.

### CROSS-REFERENCE TO RELATED APPLICATIONS

Priority is claimed to U.S. Provisional Patent Application No. 61/689,945, filed Jun. 15, 2012, herein incorporated by reference in its entirety.

### FIELD OF THE INVENTION

This invention pertains to processes for removing N-nitrosodimethylamine (NDMA) from water by catabolic mechanisms, and more particularly to co-metabolic processes involving the use of certain oxygenated hydrocarbons.

### BACKGROUND

NDMA is a contaminant introduced into the environment from activities in making and using hydrazine-based rocket fuels, explosives and other sources. NDMA may also form during chlorine disinfection of wastewater or ozonation of water. NDMA, when present, is frequently in a very low concentration, say, less than about 100 nanograms per liter. Nevertheless concerns about NDMA being a potential human carcinogen and mutagen have led to efforts to have NDMA reduced to under 10, and particularly below about 1, nanograms per liter of contaminated water.

The reduction of NDMA contamination to such low levels poses challenges to effect removal in an effective and efficient manner without undue capital and operating costs. Potential processes for removal of NDMA include UV photolysis and membrane separations; however, NDMA does not significantly sorb to activated carbon, clays or cation exchangers, and strong anion exchangers can lead to the formation of NDMA. Proposals have been made to remove NDMA through biological processes. The identification of enzymes capable of catabolizing NDMA is challenging since it is not typically present in the environment except through activities of man. Prior workers have devoted efforts to identifying microorganisms and enzymes that have the capability of degrading NDMA. In general, they have found that enzymes capable of degrading NDMA are operable only in the presence of a substrate that activates the enzyme. Microorganisms such as Rhodococcus sp. that that have been grown on propane, methane or toluene have been shown, under aerobic conditions, to rapidly oxidize NDMA. The process is thought to be a co-metabolic process where the NDMA provides little, if any, benefit to the cells. See, for instance, Sharp, et al., An Inducible Propane Monooxygenase Is Responsible for N-Nitrosodimethylamine Degradation by Rhodococcus sp. Strain RHA1, Applied and Environmental Microbiology, Vol. 73, No 21, November 207, p. 6930-6938. Due to the low solubilities of methane and propane in contaminated water, mass transfer difficulties can exist in providing these components to the cells. Toluene poses toxicity issues. Thus post treatment of the water may be required to remove the hydrocarbons introduced into the water.

Sharp, et al, in Aerobic Biodegradation of N-Nitrosodimethylamine (NDMA) by Axenic Bacterial Strains, Biotechnology and Bioengineering, Vol. 89, No. 5, Mar. 5, 2005, screened a number of bacterial strains for ability to degrade NDMA. In Table I they report that Rhodococcus, sp. RR1 grown on soy broth had the ability to degrade NDMA at a rate of about 13 nanograms per milligram per minute. The authors stated that this strain, when grown on toluene, also degrades NDMA.

U.S. Pat. No. 5,656,169 discloses degrading NDMA in a plant treating toxic waste water.

An enzyme has been identified in Rhodococcus erythropolis that is effective in oxidizing ethanol, other primary alcohols and benzyl alcohol on in the presence of p-nitroso-N,N-dimethyl aniline as an electron acceptor. The oxidation product is an aldehyde. (UniProtKB database accession number P81747 (ADHN_RHOER) last modified Apr. 3, 2013, Version 27, http://www.uniprot.org/uniprot/P81747) Another enzyme has been identified in Rhodococcus erythropolis that catalyzes the oxidation of alcohols with the concomitant reduction of p-nitroso-N,N-dimethyl aniline, aldehydes or ketones. ((UniProtKB database accession number Q53062 (MEDH_RHOER) last modified Apr. 3, 2013, Version 41, http://www.uniprot.org/uniprot/Q53062) Although p-nitroso-N,N-dimethyl aniline is an analog of NDMA, neither of these enzymes provide an alternative to the use of the aerobic biodegradation processes disclosed by Sharp, et al., for oxidizing NDMA in the treatment of water.

Often NDMA is found in water also contaminated with halogenated hydrocarbons also formed in making explosives and rocket fuels. Halogenated hydrocarbons frequently inhibit metabolic processes.

Accordingly, processes are sought to reduce the concentration of NDMA in water to ultralow levels an effective and efficient manner.

### SUMMARY OF THE INVENTION

By this invention it has been found that NDMA can be degraded by Rhodococcus sp. in the presence of sufficient amounts of at least one oxygenated hydrocarbon selected from the group consisting of secondary alcohols, ketones and aldehydes and having up to five carbon atoms. Advantageously, the solubility of these oxygenated hydrocarbons in water facilitates their mass transport to the microorganism. This enables the use of a near 1:1 mole ratio of NDMA to oxygenated hydrocarbon such that subsequent treatment of the water to remove excess oxygenated hydrocarbon such that the water meets desired quality may not be required. In the preferred aspects of this invention, the mole ratio of the oxygenated hydrocarbon to NDMA is in the range of about 5:1 to 1:1, preferably the treated water contains less than about 1, more preferably less than about 0.05, micrograms per liter. Moreover, many of the suitable oxygenated hydrocarbons that enable the degrading of NDMA, are thought to pose no risk to humans or the environment at the ultra-low concentrations required for effecting the degradation of NDMA.

In one broad aspect of the invention, processes are provided for the reduction of NDMA in water comprising contacting the water with Rhodococcus sp. under metabolic conditions including the presence of sufficient oxygenated hydrocarbon selected from the group consisting of secondary alcohols, ketones and aldehydes having up to five carbon atoms in an amount sufficient to enable the degradation of NDMA. Preferably the oxygenated hydrocarbon comprises at least one i-alkanol or ketone, and most preferably the alkanol has three or four carbon atoms and the ketone is acetone or methyl ethyl ketone. In many instances, the concentration of the NDMA in the water to be treated is less than about 100 nanograms per liter (ng/L) and the concentration of NDMA is reduced by at least 50%, preferably to less than 10 ng/L, and most preferably below 1 ng/L. In preferred aspects of the invention, the degradation of NDMA is not unduly inhibited by the presence of halogenated hydrocarbons.

### DETAILED DESCRIPTION

All patents, published patent applications and articles referenced in this detailed description are hereby incorporated by reference in their entireties.

Definitions

As used herein, the following terms have the meanings set forth below unless otherwise stated or clear from the context of their use.

The use of the terms “a” and “an” is intended to include one or more of the element described.

Bioconversion activity is the rate of consumption of substrate per hour per gram of microorganism. Where an increase or decrease in bioconversion activity is referenced herein, such increase or decrease is ascertained under similar bioconversion conditions including concentration of substrate and product in the aqueous medium. Bioconversion activity to bioproduct is the rate of production of the bioproduct per hour per gram of microorganism.

Metabolic conditions include conditions of temperature, pressure, oxygenation, pH, and nutrients (including micronutrients) and additives required or desired for the microorganisms in the biocatalyst. Nutrients and additives include growth promoters, buffers, antibiotics, vitamins, minerals, nitrogen sources, and sulfur sources and carbon sources where not otherwise provided.

Population of microorganisms refers to the number of microorganisms in a given volume and include substantially pure cultures and mixed cultures.

Substrates are carbon sources, electron donors, electron acceptors and other chemicals that can be metabolized by a microorganism, which chemicals, may or may not provide sustaining value to the microorganisms.

References to organic acids herein shall be deemed to include corresponding salts and esters.

The processes of this invention pertain to the degradation of NDMA by Rhodococcus sp. where and oxygenated hydrocarbon is provided to obtain the catabolic activity.

The concentration of NDMA in the contaminated water can vary over a wide range. And heavily contaminated water, it is possible that the concentration of NDMA is greater than 1 mcg/L. However, most contaminated water sources contain less than about 100 ng/L of NDMA, say, between about 5 and 100 ng/L. The water may contain other contaminants, especially those associated with hydrazine propellants and explosives including halogenated hydrocarbons such as perchlorates, dichloroethylene trichloroethylene, tetrachloroethylene and tetrachloroethane. In many instances the microorganisms may be able to degrade these halogenated hydrocarbons, and the oxygenated hydrocarbon should be in a concentration sufficient to induce degradation of these halogenated hydrocarbons as well as the NDMA.

The oxygenated hydrocarbon used to enable the enzyme to degrade NDMA includes secondary alcohols, aldehydes, and ketones of 1 to 5 carbon atoms such as isopropanol, isobutanol, acetaldehyde, propionaldehyde, acetone, and methyl ethyl ketone and the like. As stated above, the preferred oxygenated hydrocarbons are secondary alcohols or ketones containing three or four carbon atoms, especially isopropanol and acetone. Mixtures of one or more oxygenated hydrocarbons can be used.

The amount of oxygenated hydrocarbon provided to the water to be treated can vary widely and will depend upon the amount of NDMA present in the water, the nature of the metabolic process and the amount of substrate required to maintain the microorganism population, and whether or not subsequent unit operations are used to reduce the concentration of any excess oxygenated hydrocarbon or the acceptable concentration of the oxygenated hydrocarbon in the water from the treatment process. The concentration of the oxygenated hydrocarbon in the water may be as great as 10 or 20 micrograms per liter (mcg/L) or more. Preferably, the mole ratio of oxygenated hydrocarbon to NDMA is at least about 1:1. In most instances the mole ratio of oxygenated hydrocarbon to NDMA is in the range of about 1:1 to 5:1.

The Rhodococcus sp. microorganisms used processes this invention contain an enzyme capable of oxidizing propane, a monooxygenase or dioxygenase enzyme. The enzyme can be found in various strains of Rhodococcus microorganisms and the microorganisms include, but are not limited to, the following strains aurantiacus, baikonurensis, coprophilus, corynebacteriodes, erythropolis, globerulus, gordoniae, jostii, koreensis, kropenstedtii, maanshanensis, marinonascens, opacus, percolates, phenolicus, polyvorum, pyridinivorans, rhodochrous, rhodnii, ruber, triatomae, tukisamuensis, wratislaviensis, yunnanensis, and zopfii. The strains may be wild strains, mutated strains and genetically modified strains to include the enzymes. A recombinant microorganism can comprise one or more heterologous nucleic acid sequences (e.g., genes). One or more genes can be introduced into a microorganism used in the methods, compositions, or kits described herein, e.g., by homologous recombination. One or more genes can be introduction into a microorganism with, e.g., a vector. The one or more microorganisms can comprise one or more vectors. A vector can be an autonomously replicating vector, i.e., a vector that exists as an extra-chromosomal entity, the replication of which is independent of chromosomal replication, e.g., a linear or closed circular plasmid, an extra-chromosomal element, a mini-chromosome, or an artificial chromosome. The vector can contain a means for self-replication. The vector can, when introduced into a host cell, integrate into the genome of the host cell and replicate together with the one or more chromosomes into which it has been integrated. Such a vector can comprise specific sequences that can allow recombination into a particular, desired site of the host chromosome. A vector system can comprise a single vector or plasmid, two or more vectors or plasmids, which together contain the total DNA to be introduced into the genome of the host cell, or a transposon. The choice of the vector will typically depend on the compatibility of the vector with the host cell into which the vector is to be introduced. The vector can include a reporter gene, such as a green fluorescent protein (GFP), which can be either fused in frame to one or more of the encoded polypeptides, or expressed separately. The vector can also include a selection marker such as an antibiotic resistance gene that can be used for selection of suitable transformants. Means of genetically manipulating organisms are described, e.g., Current Protocols in Molecular Biology, last updated Jul. 25, 2011, Wiley, Print ISSN: 1934-3639. In some embodiments, one or more genes involved in byproduct formation are deleted in a microorganism. In some embodiments, one or more genes involved in byproduct formation are not deleted. Nucleic acid introduced into a microorganism can be codon-optimized for the microorganism. A gene can be modified (e.g., mutated) to increase the activity of the resulting gene product (e.g., enzyme). Sought properties in wild-type or genetically modified microorganisms can often be enhanced through a natural modification process, or self-engineering process, involving multigenerational selective harvesting to obtain strain improvements such as microorganisms that exhibit enhanced properties such as robustness in an environment or bioactivity. See, for instance, Ben-Jacob, et al., Self-engineering capabilities of bacteria, J. R. Soc. Interface 2006, 3, doi: 10.1098/rsif.2005.0089, 22 Feb. 2006.

The metabolic conditions to provide for the degradation of the NDMA are not critical to the processes of this invention. In general, metabolic conditions will include a temperature in the range of between about 5° C. to 45° C., or more, say, between about 10° C. to 40° C. In most instances, the pressure ranges from about 70 to 500, say, 90 to 300, kPa absolute due to equipment configurations although higher and lower pressures could find applicability. The pH of the water to be treated will depend upon its source. In general, the pH is maintained between about 4 and 8.5, for instance, between 5.5 and 8.0. Buffers, if desired, may be used to maintain the water at a given pH value during the process. The metabolic conditions are aerobic, and often the concentration of molecular oxygen in the water is at least about 1, say, in the range of about 2 to 20 or more milligrams per liter.

The water to be treated may contain sufficient nutrients, including micronutrients, to maintain the microorganisms. If needed, nutrients and additives such as growth promoters, buffers, antibiotics, vitamins, minerals, nitrogen sources, and sulfur sources may be added as is known in the art. If needed, electron donors can be added to the water to be treated. Electron donors include, but are not limited to, hydrogen, carbohydrates, hydrocarbons, alkanols, aldehydes, carboxylic acids, ketones, aldehydes, glycerides and the like. See, for instance, paragraph 0055 of U.S. Published Patent Application No. 2006/0263869. If electron donors are required, they may be added in any suitable manner. Usually the amount added is sufficient to provide the sought biodegradation.

The duration of the contact is for time sufficient to obtain the sought reduction in NDMA. Preferably the duration of contact is sufficient to provide a reduction of at least about 50, or preferably at least about 70, percent and provide a treated water containing less than about 10 ng/L, preferably less than about 1 ng/L, of NDMA. The duration can vary over a wide range depending upon the type of reactor, the density of the microorganism population, the sought reduction of the NDMA concentration and the metabolic conditions. In most instances, the hydraulic retention time for continuous processes is less than about 5 hours, and is often in the range of about 5 to 200 minutes.

The process may be conducted in a batch, or semi-batch, mode, but is most advantageously practiced in a continuous manner using microorganisms attached to or retained in a support to facilitate separation of the treated water from the microorganisms. Supports include, but are not limited to, charcoal, activated carbons, ion exchange resins, molecular sieves, clays, polymeric structures especially structures having a substantial internal void volume, and the like. A preferred structure is a biocatalyst which is an open, porous matrix composed of hydrophilic polymer defining interior cavities containing microorganisms. Often these interior cavities have a smallest dimension of between about 1 and 100 microns.

Reactor designs, especially for supported microorganisms include, but are not limited to, bubble column reactors, stirred reactors, packed bed reactors, trickle bed reactors, fluidized bed reactors, plug flow (tubular) reactors, and membrane (biofilm) reactors. More than one reactor vessel may be used. For instance, reactor vessels may be in parallel or in sequential flow series.

### EXAMPLES

The following examples are for purposes of illustration only and are not in limitation of the invention. All parts and percentages of solids are by mass and of liquid are by volume unless otherwise stated or clear from the context.

A series of batch experiments are conducted each using the substantially the following procedure. A master batch of each Rhodococcus strain used is prepared from centrifuged and washed cells. The washing is a single wash using an M9 aqueous solution containing disodium hydrogen phosphate (6g/L), potassium biphosphate (3 g/L), sodium chloride (0.5 g/L), ammonium chloride (1 g/L), magnesium sulfate (0.5 g/L), calcium chloride (0.01 g/L), yeast extract (0.1 g/L) and sucrose (4 g/L). The centrifuged and washed cells are suspended in an M9 solution in a concentration of about 15 grams of the wet, centrifuged cell-containing mass per liter to prepare the master batch.

For each of the below examples, about 1 parts by volume of the selected master batch is added to 40 parts by volume of water in a glass flask. The water contains about 15 grams of M9 per liter. The water in the flask is then inoculated with NDMA to provide a concentration of about 50 parts per billion per liter and any added oxygenated hydrocarbon. The water in example 5 is also inoculated with trichloroethane.

Table I summarizes the series of batch experiments.

TABLE I

| | | | Substantial | |
|---|---|---|---|---|
| | | Added oxygenated | NDMA | Rate of |
| | | hydrocarbon, (mole | degradation | NDMA |
| Example | Microorganism | ratio to NDMA) | observed? | degradation |
| 1 | Rhodococcus rhodochrous | Acetone (3:1) | yes | fast |
| 2 | Rhodococcus rhodochrous | Isopropyl alcohol | yes | fast |
| | | (3:1) | | |
| 3 | Rhodococcus rhodochrous | Acetone (1:1) | yes | medium |
| 4 | Rhodococcus rhodochrous | 50:50 | yes | medium |
| | | acetone:isopropyl | | |
| | | alcohol (1:1) | | |
| 5 | Rhodococcus rhodochrous | 50:50 | yes | fast |
| | | acetone:isopropyl | | |
| | | alcohol (5:1) | | |
| | | (trichloroethane | | |
| | | present in an amount | | |
| | | of 10 micrograms | | |
| | | per liter) | | |
| 6 | Rhodococcus ruber | Methylethylketone | yes | medium |
| | | (5:1) | | |
| 7 | Rhodococcus erythorpolis | Isobutanol (5:1) | yes | medium |
| 8 | Rhodococcus rhodochrous | none | no | very slow |
| 9 | Rhodococcus, sp. RR1 | 50:50 | yes | slow |
| | | acetone:isopropyl | | |
| | | alcohol (5:1) | | |
| 10 | Rhodococcus ruber | 50:50 | yes | medium |
| | | acetone:isopropyl | | |
| | | alcohol (5:1) | | |

It is claimed:

1. A process for reducing the concentration of NDMA in water comprising contacting the water with Rhodococcus sp. under metabolic conditions including the presence of sufficient oxygenated hydrocarbon selected from the group consisting of secondary alcohols, ketones and aldehydes and having up to five carbon atoms in an amount sufficient to degrade NDMA.

2. The process of claim 1 wherein the Rhodococcus is one or more of the following strains: aurantiacus, baikonurensis, coprophilus, corynebacteriodes, erythropolis, globerulus, gordoniae, jostii, koreensis, kropenstedtii, maanshanensis, marinonascens, opacus, percolates, phenolicus, polyvorum, pyridinivorans, rhodochrous, rhodnii, ruber, triatomae, tukisamuensis, wratislaviensis, yunnanensis, and zopfii.

3. The process of claim 1 wherein the oxygenated hydrocarbon comprises at least one secondary alcohol or ketone.

4. The process of claim 3 wherein the secondary alcohol has three or four carbon atoms and the ketone is acetone or methyl ethyl ketone.

5. The process of claim 1 wherein the concentration of the NDMA in the water to be treated is less than about 100 nanograms per liter (ng/L) and the concentration of NDMA is reduced by at least 50% to less than 10 ng/L.

6. The process of claim 1 wherein the water also contains halogenated hydrocarbon.

7. The process of claim 1 wherein the mole ratio of the oxygenated hydrocarbon to NDMA is in the range of about 5:1 to 1:1.

8. The process of claim 1 wherein the Rhodococcus is on or in a solid support.
